(19) United States
(12) Patent Application Publication
(10) Pub. No.: US 2002/0059532 A1
(43) Pub. Date: May 16, 2002

(54) Device and method for authentication

(76) Inventors: Teruaki Ata, Osaka (JP); Kiyomi Sakamoto, Ikoma (JP); Atsushi Yamashita, Osaka (JP); Hiroyuki Hamada, Yawata (JP)

Correspondence Address: WENDEROTH, LIND & PONACK, L.L.P., 2033 K STREET N. W., SUITE 800, WASHINGTON, DC, 20006-1021, US

(21) Appl. No.: 09/969,620

(22) Filed: Oct. 4, 2001

(30) Foreign Application Priority Data
Nov. 16, 2000 (JP) 2000-349875

(51) Int. Cl. H04L 9/32

(52) U.S. Cl. 713/202

(57) ABSTRACT

A current position detection part 15 detects vehicle history information varying with use of a vehicle. A storage part 13 stores the vehicle history information. At authentication, an output part 12 gives a question about the vehicle history information, and the user inputs through an input part 11 an answer to the question. An information processing part 14 determines whether the answer is correct, based on the vehicle history information stored in the storage part 13 and the answer from the user, thereby authenticating the user of the vehicle.

### BACKGROUND OF THE INVENTION

1. Field of the Invention

The present invention relates to authentication devices and, more specifically, to an authentication device for authenticating a user of a vehicle.

2. Description of the Background Art

One conventional method for authenticating a user of a vehicle is carried out by using a mechanical cylinder key for starting the engine of the vehicle. The engine cannot be started without an authorized key, thereby preventing theft of the vehicle. Such mechanical key, however, is rather easy to copy, and therefore is not sufficiently able to prevent theft.

In another method, as disclosed in Japanese Patent Examined Publication No. 4-15141 (1992-15141), specific electronic information is included in the key to make it hard to copy, thereby strengthening vehicle-theft prevention. If the authorized key is stolen, however, it is impossible to prevent theft of the vehicle. Therefore, this is also not sufficient for theft-prevention.

To get around these problems above, one method is carried out by authenticating a user using personally identifiable information for vehicle-theft prevention. As disclosed in Japanese Patent Laid-Open Publication Nos. 7-168930 (1995-168930), 2000-168502, and 2000-85536, for example, user recognition devices for vehicles are suggested which authenticate a user through personal identification by detecting his/her biological characteristics such as fingerprints and irises. In another method for authenticating a user through personal identification, an authentication device using a password as an authentication key has been conventionally known.

In the user authentication method with biological characteristic detection, a unit for detecting such characteristics is required, which increases the authentication device in size and cost. On the other hand, in the password-utilizing method, repetitive use of the same password reduces security in authentication. Therefore, the password has to be regularly changed, which increases a burden on the user.

### SUMMARY OF THE INVENTION

Therefore, an object of the present invention is to provide an authentication device and method for authenticating a user of a vehicle through a technique not yet known to date, with high security, in small size, and at low cost.

The present invention has the following features to attain the object above.

A first aspect of the present invention is directed to an authentication device for authenticating a user of a vehicle that includes:

a vehicle history information detecting part for detecting vehicle history information varying with use of the vehicle;

a vehicle history information storage part for storing the vehicle history information detected by the vehicle history information detection part;

an output part for outputting a question about the vehicle history information;

an answer input part being supplied with an answer from the user to the question about the vehicle history information; and

a user authentication part for authenticating the user based on the vehicle history information stored in the vehicle history information storage part and the answer from the user.

In accordance with the above first aspect, the vehicle history information is used for user authentication. The vehicle history information is information varying with use of the vehicle, and capable of identifying the vehicle. For example, the vehicle history information varies with time or traveling of the vehicle. The vehicle history information exemplarily includes history of passing points, information about points such as the starting point and the destination, information about routes such as what routes were taken, the remaining amount of gasoline, the speed of the vehicle, and reception history under VICS (Vehicle Information and Communication System). Such vehicle history information is known only to the authorized user who operated the vehicle, varied as the vehicle is used, and therefore less possibly falls under unauthorized use. For this reason, using the vehicle history information improves authentication security, compared with using a fixed password as authentication information. Moreover, unlike authentication devices using biological characteristics for authentication, the present authentication device can carry out authentication without requiring any detection unit for detecting these characteristics. Therefore, the authentication device can be achieved in small size and cost.

According to a second aspect of the present invention, in the first aspect, the vehicle history information includes point history information indicating history of one or more predetermined points.

In accordance with the above second aspect, the point history information is used for user authentication. The point history information represents history of a specific point that the vehicle has passed or dropped by. The user can remember such point history information rather easily. Therefore, according to the above second aspect, using the point history information for authentication can reduce a burden of remembering on the user.

According to a third aspect of the present invention, in the second aspect, the point history information includes, for one or more points registered in advance by the user, information about time/date when the vehicle previously passed the registered points and time/date when the vehicle was used on a previous use.

In accordance with the above third aspect, a point or facility the user often passes or goes to is selected, and history of the selected point can be used for authentication. The user can easily remember such history, and easily answer to a question at authentication, and therefore is less burdened with remembering. Moreover, according to the above third aspect, the user is provided with a question about what time and date the user passed that point, which are easily remembered by the user. Thus, the user is also less burdened with remembering.

According to a fourth aspect of the present invention, in the third aspect,

the user authentication part selects an arbitrary point from the registered points, and

the output part outputs a question about whether the vehicle passed, on the previous use, the point selected by the user authentication part and, if the vehicle passed the point, a question about what time the vehicle passed the point on the previous use.

In accordance with the above fourth aspect, the user authentication part automatically selects a point, and a question about history of the selected point can be given. Thus, the user is not required to select any point, and therefore less burdened with operation.

According to a fifth aspect of the present invention, in the third aspect, the answer input part is supplied with a point selected by the user from the registered points, and

the output part outputs a question about when the vehicle previously passed the point supplied to the answer input part.

In accordance with the above fifth aspect, the user selects by himself/herself a point, and then is provided with a question about what time the vehicle previously passed that point. Therefore, the user only answers the passage time of the point of which he/she remembers history. Thus, the user is further less burdened with remembering.

According to a sixth aspect of the present invention, in the first aspect, the authentication device further includes a personal information storage part for storing information unique to the user and/or personal information including a password previously set by the user, wherein

the output part outputs the question about the vehicle history information when an elapsed time after the previous use of the vehicle is within a predetermined time period, and a question about personal information when the elapsed time is over the predetermined time period,

the answer input part is supplied with an answer to the question about the vehicle history information when the elapsed time is within the predetermined time period, and an answer to the question about the personal information when the elapsed time is over the predetermined time period, and

the user authentication part authenticates the user based on the vehicle history information and the answer from the user when the elapsed time is within the predetermined time period, and based on the personal information and the answer from the user when the elapsed time is over the predetermined time period.

In accordance with the above sixth aspect, the personal information is used for authentication when the user has not used the vehicle for a predetermined time period. In general, the user forgets the vehicle history information as a predetermined time elapses after the last use of the vehicle. In such case, the personal information, which the user can surely remember, is suitable for use in authentication because it is less burdensome for the user to remember. Therefore, according to the above sixth aspect, it is possible to provide an authentication device that reliably carries out authentication with a less burden of remembering upon the user even if he/she has not used the vehicle.

According to a seventh aspect of the present invention, in the first aspect, the authentication device further includes a power-feeding part for carrying out power-feeding to an engine of the vehicle, wherein

the user authentication part makes the power-feeding part carry out the power-feeding if having authenticated the user.

In accordance with the above seventh aspect, the use of the vehicle is allowed only when the user has been authenticated. Therefore, with the authentication device using the vehicle history information, protection against theft of the vehicle can be achieved.

According to an eighth aspect of the present invention, in the first aspect, the authentication device further includes a power-feeding part for carrying out power-feeding to an engine of the vehicle;

a key authentication part for carrying out authentication using a key and, if having authenticated the key, making the power-feeding part carry out the power-feeding; and

a restrictive instruction input part being supplied with an instruction for restricting the use of the vehicle,

wherein

the user authentication part carries out authentication in response to the instruction for restricting the use of the vehicle and, if having authenticated the user, prohibits the power-feeding part from carrying out the power-feeding done by the key authentication part.

In accordance with the above eighth aspect, by carrying out authentication using the vehicle history information, the authentication device can prohibit the vehicle's use allowed by authentication using the key. Therefore, even if the key is stolen, the user carries out authentication using the vehicle history information to prevent theft of the vehicle. Furthermore, for ordinary use of the vehicle, the user only carries out authentication using the key, and therefore is saved time and trouble required for authentication when using the vehicle.

According to a ninth aspect of the present invention, in the eighth aspect, the authentication device further h includes a use instruction input part for inputting an instruction for using the vehicle, wherein

the user authentication part carries out authentication in response to the instruction for using the vehicle and, if having authenticated the user, makes the power-feeding part carry out the power-feeding.

In accordance with the above ninth aspect, the authentication device carries out authentication using the vehicle history information to allow the use of the vehicle. Therefore, the user can use the vehicle even if the use of the vehicle is restricted based on the results of authentication using the key.

According to a tenth aspect of the present invention, in the first aspect,

the authentication device further includes a power-feeding part for carrying out power-feeding to an engine of the vehicle;

a key authentication unit for carrying out authentication using a key and, if having authenticated the key, making the power-feeding part carry out the power-feeding; and

a reporting part for reporting to the user that the vehicle is under unauthorized use, when the user authentication part did not authenticate the user within a predetermined time period after the power-feeding part carried out the power-feeding.

In accordance with the above tenth aspect, only authentication using the key is carried out when the user is about to get on the vehicle. Authentication using the vehicle history information is carried out after the use of the vehicle is started. Therefore, when getting on the vehicle, the user carries out only authentication that can be easily performed in a short time. Moreover, if authentication using the vehicle history information has not been carried out, the authorized user is so notified. Therefore, if the person who is going to use the vehicle is the authorized user, authentication using the vehicle history information does not have to be carried out. Thus, according to the above tenth aspect, the authorized user can use the vehicle with only simple authentication using the key. Moreover, according to the above tenth aspect, highly-secured authentication using the vehicle history information can be carried out for unauthorized users.

According to an eleventh aspect of the present invention, in the first aspect, the authentication device is constructed as part of a car navigation system.

In accordance with the eleventh aspect, the authentication device is constructed using a car navigation system. The car navigation system has functions of receiving information from the user, outputting information as an image and/or audio to the user, storing the vehicle history information, and detecting the current position of the vehicle. Therefore, to achieve the authentication device according to the present invention, the car navigation system can be utilized. Thus, according to the above eleventh aspect, the authentication device of the present invention can be achieved without requiring a new device installed.

A twelfth aspect of the present invention is directed to an authentication device capable of communicating with an input terminal that outputs a question about vehicle history information varying with use of a vehicle and is supplied with an answer to the question, and the authentication device includes:

a vehicle history information detection part for detecting the vehicle history information;

a vehicle history information storage part for storing the vehicle history information detected by the vehicle history information detection part;

a communications part for transmitting the question about the vehicle history information and receiving the answer to the question from a user through the input terminal; and

a user authentication part for authenticating the user based on the vehicle history information stored in the vehicle history storage part and the answer from the user.

In accordance with the above twelfth aspect, compared with a case where a fixed password is used as authentication information, the vehicle history information is less possibly under unauthorized use. Therefore, authentication security is improved. Moreover, compared with the authentication device carrying out authentication using biological characteristics, the present authentication device can carry out authentication without requiring any detection unit for detecting these characteristics. Therefore, the authentication device can be achieved in small size and cost.

Furthermore, in accordance with the above twelfth aspect, the user can carry out authentication outside of the vehicle by using an input terminal. Therefore, the user can carry out authentication using the vehicle history information before he/she gets on the vehicle. Thus, the user is not required to carry out burdensome authentication when getting on the vehicle, and therefore saved time and trouble.

A thirteenth aspect of the present invention is directed to a vehicle-mounted authentication system including an authentication device for authenticating a user of a vehicle and an input terminal capable of communicating with the authentication device, wherein

the authentication device includes:

a vehicle history information detection part for detecting vehicle history information varying with use of the vehicle;

a vehicle history information storage part for storing the vehicle history information detected by the vehicle history information detection part;

a communications part for transmitting a question about the vehicle history information to the input terminal and receiving an answer to the question from the user through the input terminal; and

a user authentication part for authenticating the user based on the vehicle history information stored in the vehicle history information storage part and the answer from the user, and

the input terminal includes:

a terminal-side output part for outputting the question about the vehicle history information transmitted by the authentication device;

a terminal-side answer input part being supplied with the answer from the user to the question about the vehicle history information; and

a terminal-side communications part for transmitting the answer from the user to the authentication device.

In accordance with the above thirteenth aspect, compared with a case where a fixed password is used as authentication information, the vehicle history information is less possibly under unauthorized use. Therefore, authentication security is improved. Moreover, compared with the authentication device carrying out authentication using biological characteristics, the present authentication device can carry out authentication without requiring any detection unit for detecting these characteristics. Therefore, the authentication device can be achieved in small size and cost.

Furthermore, in accordance with the above thirteenth aspect, the user can carry out authentication outside of the vehicle by using an input terminal. Therefore, the user can carry out authentication using the vehicle history information before he/she gets on the vehicle. Thus, the user is not required to carry out burdensome authentication when getting on the vehicle, and therefore saved time and trouble.

According to a fourteenth aspect, in the thirteenth aspect, the authentication device further includes:

a power-feeding part for carrying out power-feeding to an engine of the vehicle; and

a key authentication part for carrying out authentication using a key and, if having authenticated the key, making the power-feeding part carry out power-feeding, and

the user authentication part carries out authentication in response to an instruction for restricting the use of the vehicle and, if having authenticated the user, prohibits the power-feeding part from carrying out the power-feeding done by the key authentication part.

In accordance with the above fourteenth aspect, by using authentication using the vehicle history information, the authentication system can prohibit the use of the vehicle allowed by the authentication using the key. Therefore, even if the key is stolen, the user carries out authentication using the vehicle history information to prevent theft of the vehicle. Also, for ordinary use of the vehicle, the user only carries out authentication using the key, and therefore is less burdened with authentication when using the vehicle.

Furthermore, according to the above fourteenth aspect, the use of the vehicle can be prohibited by the use of an input terminal. That is, the user can prohibit the use of the vehicle from outside of the vehicle without getting inside. Therefore, when the key is stolen and the user does not have any spare key to get inside the vehicle, the user can prohibit the use of the vehicle.

According to a fifteenth aspect of the present invention, in the fourteenth aspect, the input terminal further includes a terminal-side use instruction input part being supplied with an instruction for using the vehicle, and

the user authentication part carries out the authentication in response to an instruction for using the vehicle and, if having authenticated the user, makes the power-feeding part carry out the power-feeding.

In accordance with the above fifteenth aspect, the authentication system can enable the use of the vehicle by authentication using the vehicle history information. Therefore, the user can use the vehicle even when the use of the vehicle is prohibited based on the results of authentication using the key.

A sixteenth aspect of the present invention is directed to an authentication system including a vehicle-side device mounted on a vehicle and an authentication terminal capable of communicating with the vehicle-side device, wherein

the vehicle-side device includes:

a vehicle history information detection part for detecting vehicle history information varying with use of the vehicle; and

a communications part for transmitting the vehicle history information detected by the vehicle history information detection part to the authentication terminal, and

the authentication terminal includes:

a terminal-side vehicle history information storage part for storing the vehicle history information transmitted from the communications part;

a terminal-side output part for outputting a question about the vehicle history information;

a terminal-side answer input part for inputting an answer from a user to the question about the vehicle history information; and

a terminal-side user authentication part for authenticating the user based on the vehicle history information stored in the terminal-side vehicle history information storage part and the answer from the user.

In accordance with the above sixteenth aspect, the vehicle history information varying with the use of the vehicle is used for authentication. Therefore,compared with a case where a fixed password is used as authentication information, the vehicle history information is less possibly under unauthorized use. Therefore, authentication security is improved. Moreover, compared with the authentication device carrying out authentication using biological characteristics, the present authentication device can carry out authentication without requiring any detection unit for detecting these characteristics. Therefore, the authentication device can be achieved in small size and cost.

Furthermore, in accordance with the above sixteenth aspect, the user can carry out authentication outside of the vehicle by using an authentication terminal. Therefore, the user can carry out authentication using the vehicle history information before he/she gets on the vehicle. Thus, the user is not required to carry out burdensome authentication when getting on the vehicle, and therefore saved time and trouble.

According to a seventeenth aspect, in the sixteenth aspect, the authentication terminal further includes a terminal-side communications part for transmitting an authentication result given by the terminal-side user authentication part to the vehicle-side device, and

the vehicle-side device further includes anti-theft processing part for carrying out processing for preventing theft of the vehicle based on the authentication result received from the terminal-side communications part.

In accordance with the above seventeenth aspect, the vehicle-side device can use the result of authentication using the vehicle history information for protection against theft of the vehicle. Therefore, by using the highly-secured authentication, the vehicle-side device can improve anti-theft effects.

According to an eighteenth aspect, in the seventeenth aspect, the anti-theft processing part includes a power-feeding part for carrying out power-feeding to an engine of the vehicle,

the vehicle-side device further includes a key authentication part for carrying out authentication using a key and, if having authenticated the user, making the power-feeding part carry out the power-feeding, and

the terminal-side user authentication part carries out authentication in response to an instruction for restricting use of the vehicle and, if having authenticated the user, makes the terminal-side communications part transmit a power-feeding disable signal to the power-feeding part, thereby prohibiting the power-feeding part from carrying out the power-feeding initiated by the key authentication part.

In accordance with the above eighteenth aspect, by using authentication using the vehicle history information, the authentication system can prohibit the use of the vehicle allowed by the authentication using the key. Therefore, even if the key is stolen, the user carries out authentication using the vehicle history information to prevent theft of the vehicle. Also, for ordinary use of the vehicle, the user only carries out authentication using the key, and therefore is less burdened with authentication when using the vehicle.

Furthermore, according to the above eighteenth aspect, the use of the vehicle can be prohibited by the use of an input terminal. That is, the user can prohibit the use of the vehicle from outside of the vehicle without getting inside. Therefore, when the key is stolen or even when the user does not have any spare key to get inside the vehicle, the user can prohibit the use of the vehicle.

According to a nineteenth aspect, in the eighteenth aspect, the authentication terminal further includes a terminal-side use instruction input part being supplied with an instruction for using the vehicle, and

the terminal-side user authentication part carries out the authentication in response to the instruction for using the vehicle and, if having authenticated the user, makes the terminal-side communications part transmit a power-feeding signal to the power-feeding part, thereby making the power-feeding part carry out the power-feeding.

In accordance with the above nineteenth aspect, the authentication system carries out authentication using the vehicle history information to allow the use of the vehicle. Therefore, the user can use the vehicle even if the use of the vehicle is restricted based on the results of authentication using the key.

According to a twentieth aspect of the present invention, in the sixteenth aspect, the vehicle-side device further includes a vehicle history information storage part for storing the vehicle history information detected by the vehicle history information detection part, and

when the use of the vehicle ends, the communication part transmits the vehicle history information stored in the vehicle history information storage part to the authentication terminal.

In accordance with the above twentieth aspect, the vehicle's history information including the previous use is stored in the authentication terminal. Therefore, the authentication terminal always stores the latest vehicle history information. Thus, accurate authentication can carried out in the authentication system.

A twenty-first aspect of the present invention is directed to an input terminal capable of communicating with a vehicle-mounted authentication device for authenticating a user of a vehicle, and the input terminal includes:

a terminal-side output part for outputting a question about vehicle history information varying with use of the vehicle transmitted from the authentication device;

a terminal-side answer input part for inputting an answer from the user to the question about the vehicle history information; and

a terminal-side communications part for transmitting the answer from the user to the authentication device.

In accordance with the above twenty-first aspect, the input terminal can carry out authentication using the vehicle history information through the authentication device. That is, the user can carry out authentication in advance even if he/she is outside of the vehicle. Thus, the user is not required to carry out burdensome authentication when getting on the vehicle, and therefore saved time and trouble.

A twenty-second aspect of the present invention is directed to an authentication terminal capable of communicating with a vehicle-side device for detecting vehicle history information varying with use of a vehicle, and the authentication terminal includes:

a terminal-side communications part for receiving, from the vehicle-side device, the vehicle history information detected by the vehicle-side device;

a terminal-side vehicle history information storage part for storing the vehicle history information received by the communications part;

a terminal-side output part for outputting a question about the vehicle history information;

a terminal-side answer input part being supplied with an answer from the user to the question about the vehicle history information; and

a terminal-side user authentication part for authenticating the user based on the vehicle history information stored in the vehicle history information storage part and the answer from the user.

In accordance with the above twenty-second aspect, a communications terminal carries out authentication using the vehicle history information. Therefore, compared with a case where a fixed password is used as authentication information, the vehicle history information is less possibly under unauthorized use. Therefore, authentication security is improved. Moreover, compared with the authentication device carrying out authentication using biological characteristics, the present authentication device can carry out authentication without requiring any detection unit for detecting these characteristics. Therefore, the authentication device can be achieved in small size and cost.

Furthermore, in accordance with the above twenty-second aspect, the user can carry out authentication outside of the vehicle by using an authentication terminal. Therefore, the user can carry out authentication using the vehicle history information before he/she gets on the vehicle. Thus, the user is not required to carry out burdensome authentication when getting on the vehicle, and therefore saved time and trouble.

A twenty-third aspect of the present invention is directed to a method for authenticating a user of a vehicle, and the method includes the steps of:

detecting vehicle history information varying with use of the vehicle;

storing the vehicle history information;

asking a question about the vehicle history information;

receiving an answer from the user to the question; and

authenticating the user based on the vehicle history information and the answer from the user.

In accordance with the above twenty-third aspect, the vehicle history information varying with the use of the vehicle is used for authentication. Therefore, compared with a case where a fixed password is used as authentication information, the vehicle history information is less possibly under unauthorized use. Therefore, authentication security is improved. Moreover, compared with the authentication device carrying out authentication using biological characteristics, the present authentication device can carry out authentication without requiring any detection unit for detecting these characteristics. Therefore, the authentication device can be achieved in small size and cost.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a vehicle having an authentication device mounted thereon according to a first embodiment of the present invention;

FIG. 2 is a block diagram illustrating the detailed structure of a storage unit 3 shown in FIG. 1;

FIG. 3 is a diagram illustrating one example of a point information data table 1321 stored in a vehicle history information storage 132 shown in FIG. 2;

FIG. 4 is a block diagram illustrating the detailed structure of an information processing unit 4 shown in FIG. 1;

FIG. 5 is a flowchart showing a flow of processing required f or authentication in a car navigation system 1 according to the first embodiment of the present invention;

FIG. 6 is a flowchart showing the detailed processing of subroutine step S1 of FIG. 5;

FIG. 7 is a flowchart showing the detailed processing of subroutine step S2 of FIG. 5;

FIG. 8 is a flowchart showing the detailed processing of subroutine step S22 of FIG. 7;

FIG. 9 is a flowchart showing the detailed processing of subroutine step S23 of FIG. 7;

FIG. 10 is a block diagram showing the structure of an authentication system according to a second embodiment of the present invention;

FIG. 11 is a block diagram showing the structure of an authentication system according to a third embodiment of the present invention;

FIG. 12 is a table showing what process is carried out or not based on the results of authentication using a plurality of authentication techniques carried out under the authentication system shown in FIG. 11;

FIG. 13 is a flowchart showing a flow of control processing by an authentication processing control device 25 shown in FIG. 11;

FIG. 14 is a block diagram showing the structure of an authentication system according to a fourth embodiment of the present invention; and

FIG. 15 is a flowchart showing a flow of processing required for authentication in an authentication terminal 7 shown in FIG. 14.

### DESCRIPTION OF THE PREFERRED EMBODIMENTS

Described first is outlines of authentication devices according to present embodiments. In the present invention, vehicle history information is used for authentication. This vehicle history information varies with the use of a vehicle, and therefore less possibly falls under unauthorized use and does not have to be changed regularly. With the use of the vehicle history information for authentication, highly-secured authentication can be achieved. Moreover, to reduce a burden of remembering on the user, such vehicle history information is preferably easy for the user to remember. Thus, the authentication devices according to the present embodiments carry out authentication using history information about any predetermined point. Here, the predetermined point is an arbitrary point that can be registered by the user, and a plurality of such points the user often passes are preferably registered. Specifically, the authentication devices according to the present embodiments carry out authentication by asking the user a questions about whether the user passed the predetermined point on the previous use and, if passed, what time and date the user passed. Note that the predetermined point registered by the user is hereinafter referred to as a registered point.

Also, the authentication devices according to the present embodiments carry out authentication by using, in combination, the history information about the predetermined point and personal information. Here, the personal information is unique to the user, typically such as the user's birthday, family construction, or a password previously set by the user. The authentication devices according to the present embodiments carry out authentication by using, in combination, the history information about the predetermined point and a password previously set by the user.

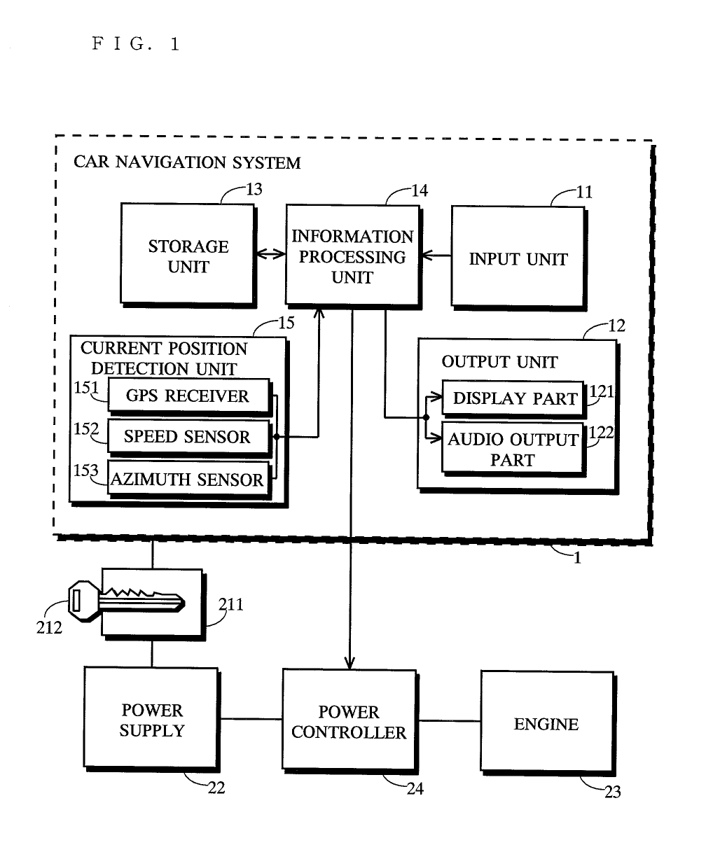

With reference to FIGS. 1 to 9, a first embodiment of the present invention is described below in detail. FIG. 1 is a block diagram showing the structure of a vehicle having an authentication device according to the first embodiment mounted thereon. The authentication device utilizes a car navigation system generally used on vehicles. In FIG. 1, a car navigation system 1 includes an input unit 11, an output unit 12, a storage unit 13, an information processing unit 14, and a current position detection unit 15. The vehicle includes a cylinder 211 and a cylinder key 212, a power supply 22, an engine 23, and a power controller 24.

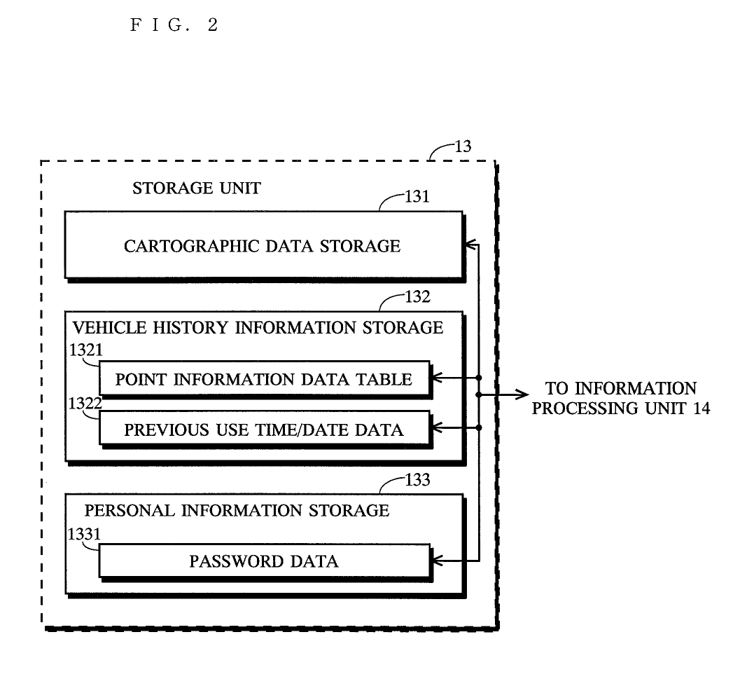

The input unit 11 is supplied with the destination at the time of route search, and outputs answers to questions at the time of authentication. The output unit 12 outputs images and audio based on cartographic data for route guide and questions for authentication. More specifically, the output unit 12 includes a display part 121 for displaying images based on the cartographic data for route guide and the questions for authentication, and an audio output part 122 for outputting audio based on the questions for authentication. The storage unit 13 stores, in addition to the cartographic data required for route search and route guide, the vehicle history information and the personal information required for authentication. The details on the storage unit 13 are shown in FIG. 2.

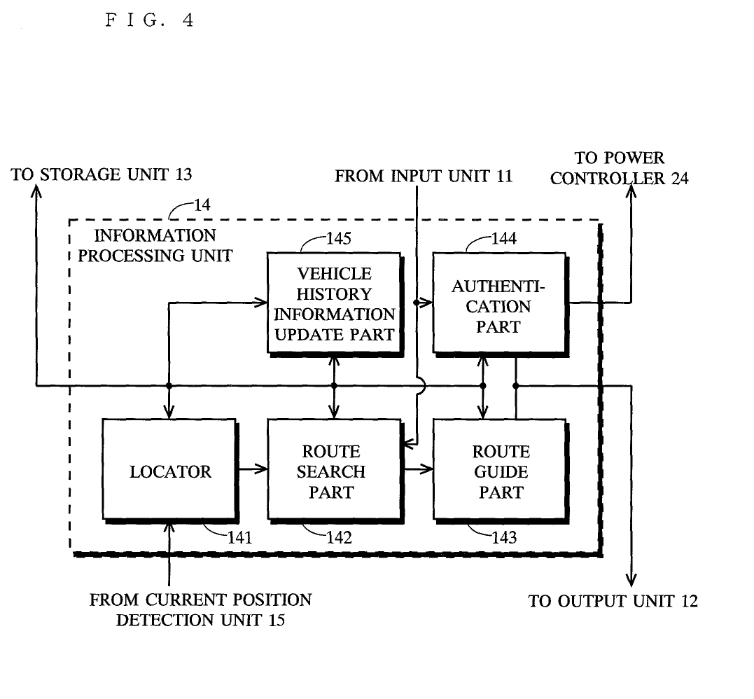

The information processing unit 14 is typically implemented by a CPU, not only for carrying out navigation as in conventional car navigation systems but for authenticating the user and updating the history information about the specific point. The details on the information processing unit 14 are shown in FIG. 4. The current position detection unit 15 detects data required for calculating the current position of the vehicle. The current position detection unit 15 includes a GPS receiver 151, a speed sensor 152, and an azimuth sensor 153. The cylinder 211 and the cylinder key 212 are used in combination as a switch for supplying electric power from the power supply 22 to the car navigation system 1. The power supply 22 supplies electric power to the car navigation system 1 and to the engine 23 of the vehicle. Power-feeding from the power supply 22 to the engine 23 is controlled by the power controller 24. That is, in response to a power-feeding enable signal from the car navigation system 1, the power controller 24 starts feeding power from the power supply 22 to the engine 23.

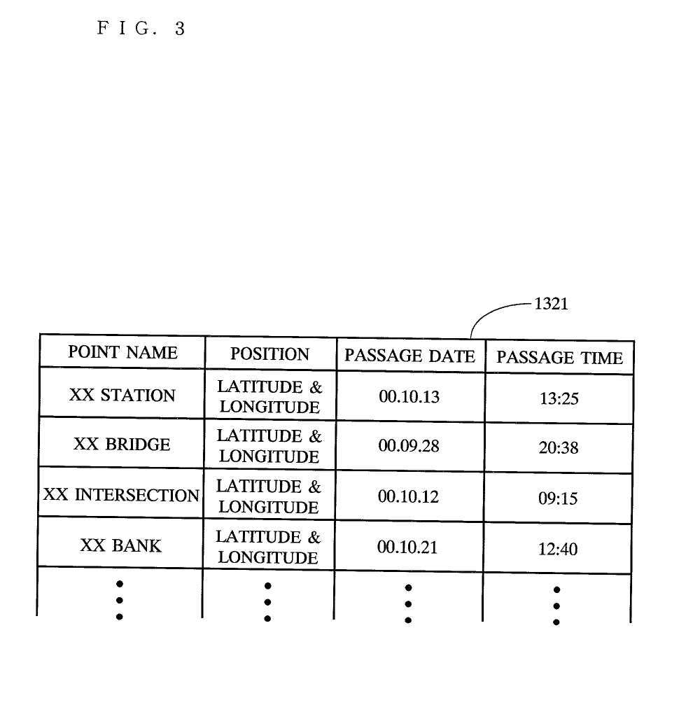

FIG. 2 is a block diagram illustrating the detailed structure of the storage unit 13 shown in FIG. 1. The storage unit 13 includes a vehicle history information storage 132 and a personal information storage 133. The cartographic data storage 131 stores cartographic data required for locating the current position. The vehicle history information storage 1321 stores the vehicle history information required for authentication. In the present embodiment, the vehicle history information storage 132 stores a point information data table 132 representing history information of points, and previous use time/date data 1322. The point information data table 1321 is shown in detail in FIG. 3. The personal information storage 133 stores password data representing a password previously set by the user.

FIG. 3 is a diagram showing one example of the point information data table 1321 shown in FIG. 2. Generally, in the conventional car navigation systems, positional information of an arbitrary point can be registered to facilitate setting the destination. Such conventional car navigation systems hold a data table containing data representing a name and position of the registered point. Here, the point information data table 1321 in the authentication device according to the present embodiment is an expansion of the data table held in the conventional car navigation systems. That is, the point information data table 1321 contains point name data representing names of the registered points, positional data representing positions of the registered points, and also passage date representing dates when the vehicle previously passed the registered points, and passage time data representing times when the vehicle previously passed the registered points. For the point name data to be registered, the user is preferably allowed to register a name easy to remember. The positional data is referred to when the passage date data and the passage time data are updated. The passage date data and the passage time data are used for authentication.

FIG. 4 is a block diagram showing the detailed structure of the information processing unit 14. Generally, the conventional car navigation systems can calculate the current position of the vehicle based on the GPS receiver, the speed sensor, and the azimuth sensor, and carry out route search and route guide between the calculated current position and the destination. Such conventional car navigation systems have a locating function of calculating the current position of the vehicle, a route search function, and a route guide function. Here, the information processing unit 14 in the authentication device according to the present embodiment is an expansion of the conventional car navigation system in function, including, in addition to a locator 141, a route search part 142, and a route guide part 143, an authentication part 144 and a vehicle history information update part 144. The locator 141 calculates the current position of the vehicle based on the information detected by the current position detection part 15. The route search part 142 searches for a route to the arbitrary destination based on the data of the vehicle's current position calculated by the locator 141, the cartographic data stored in the storage unit 13, and data of the destination supplied by the input unit 11. The route guide part 143 carries out route guide by making the output unit 12 display the route based on the information of the route found by the route search part 142 and the cartographic data stored in the storage unit 13. Note that the locator 141, the route search part 142, and the route guide part 143 are constructed similarly in the conventional car navigation systems, as described above.

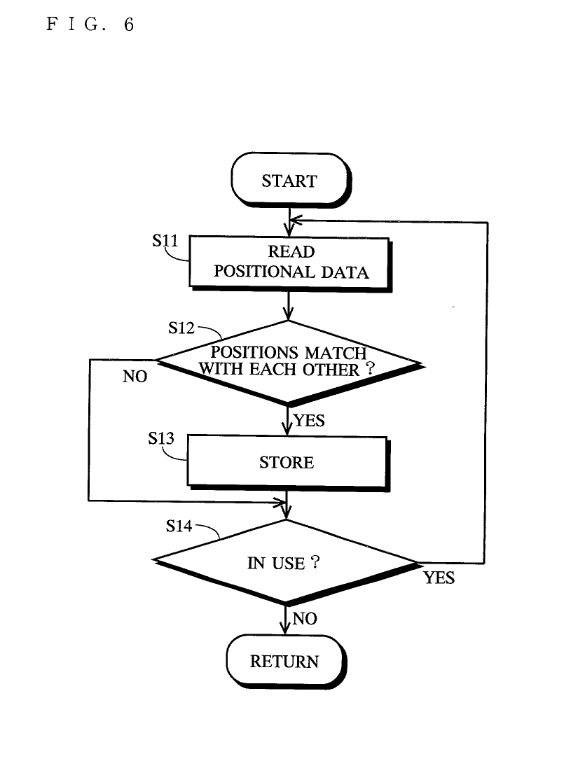

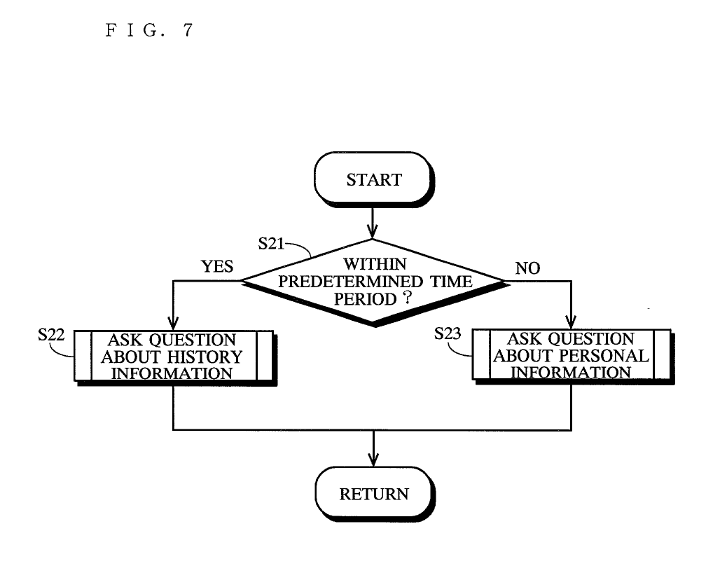

The authentication part 144 carries out authentication when the user gets on the vehicle. Specifically, at the time of authentication, the authentication part 144 selects questions to the user, makes comparison about the point information and the personal information, and determines whether the user correctly answered the questions. The details about the authentication part 144 are shown in FIGS. 7 through 9. Also, if authentication has succeeded, the authentication part 144 transmits a power-feeding enable signal to the power controller 24. The vehicle history information update part 145 updates the vehicle history information. Specifically, the vehicle history information update part 145 determines whether to update the point information data table 1321, and updates it if required. The details on the update processing are illustrated in FIG. 6.

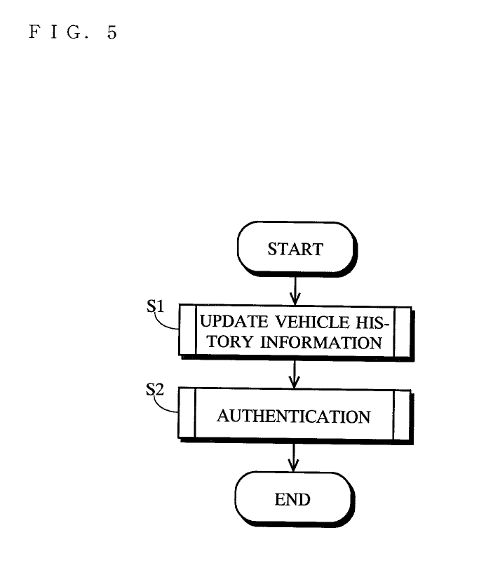

FIG. 5 is a flowchart showing the processing required for authentication in the car navigation system 1 according to the first embodiment of the present invention. First, the car navigation system 1 updates the vehicle history information used for authentication (step S1). Specifically, the vehicle history information is updated by the vehicle history information update part 145 during the previous use of the vehicle. If another processing is being carried out in the information processing unit 14, the vehicle history information is updated by an interrupt every time the locator 141 locates the current position, or by a subroutine call. Note that the details on subroutine step S1 are illustrated in FIG. 6.

Next, the car navigation system 1 carries out authentication (step S2). Specifically, authentication is carried out by the authentication part 144 when the user gets on the vehicle. In other words, authentication starts when the user inserts the cylinder key 212 into the cylinder 211 to supply power from the power supply 22 to the car navigation system 1. Note that the details on subroutine step S2 are illustrated in FIGS. 7 to 9.

FIG. 6 is a flowchart showing the detailed processing of subroutine step S1 of FIG. 5. Here, the vehicle history information update part 145 carries out updating by using, as the positional data of the point information data table 132, coordinate data of latitude and longitude used in the car navigation system 1. With reference to FIG. 6, described below is the processing of updating the vehicle history information.

First, the vehicle history information update part 145 reads the positional data representing the vehicle's current position calculated by the locator 141 (step S11). The process in step S11 is carried out when the locator 141 locates the current position. The vehicle history information update unit 145 then determines whether the current position of the vehicle matches with the position of any one of the registered points (step S12). The determination in step S12 is made by comparing the positional data representing the vehicle's current position calculated by the locator 141 with the positional data representing each registered point in the point information data table 1321.

61 The determination process in step S12 is described in detail. First, the vehicle history information update unit 145 calculates, in coordinate data, a distance between the vehicle's current position and the position of each registered point. If the calculated distance is not more than a predetermined value, the vehicle history information update part 145 determines that the vehicle's current position matches with the position of the registered point. On the other hand, if the calculated distance is more than the predetermined value, the vehicle history information update part 145 determines that the vehicle's current position does not match with the position of the registered point. Here, the predetermined value is set to a value (20 m, for example) with which it is reasonable to determine that the vehicle's position matches with the position of the registered point, in such a case that the vehicle traveling down a road has just come in front of the registered point.

In the determination process in step S12, if the vehicle's current position matches with the position of any one of the registered points, the vehicle history information update unit 145 updates the point information data table 1321 (step S13). The update process in step S13 is made by rewriting the passage date data and the passage time data for the registered point determined as matching with the current position of the vehicle in the position information data table 1321 to data representing the current data and the current time, respectively. If the vehicle's current position does not match with any registered point's position, on the other hand, the vehicle history information update part 145 does not update the point information data table 1321, and carries out the process in step S14.

The vehicle history information update part 145 then determines whether the vehicle is being used or not. If the vehicle is not being used, the vehicle history information update part 145 repeats the processing in steps S11 through S13. If not being used, on the other hand, the vehicle history information update part 145 ends the update processing.

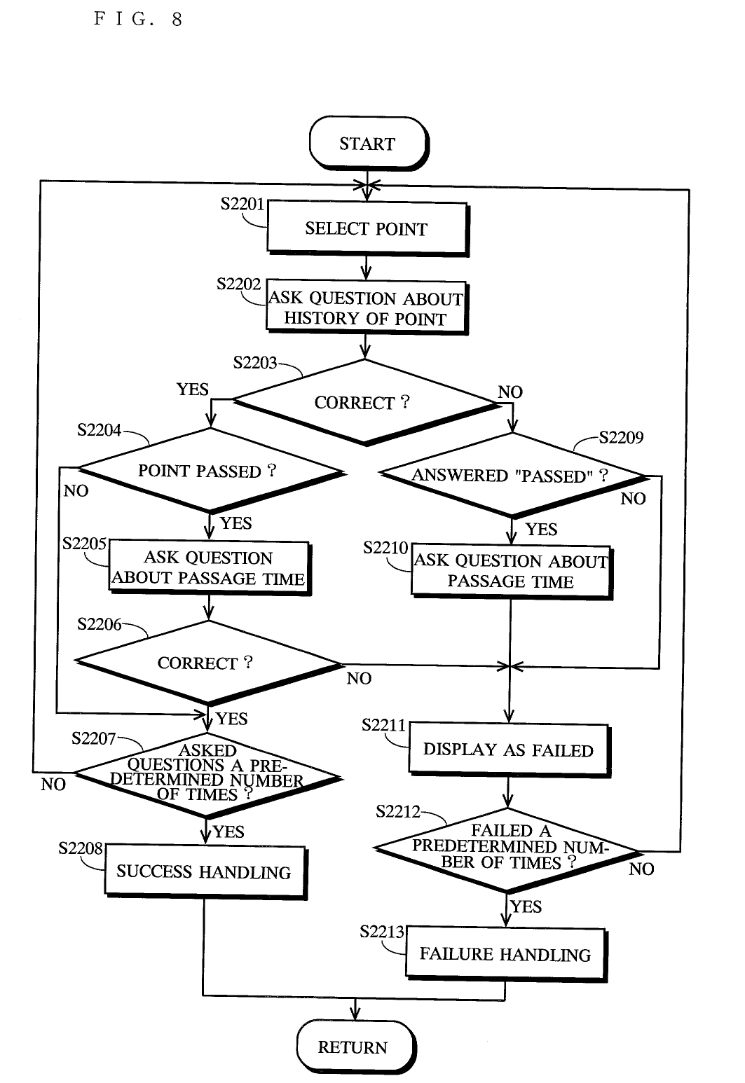

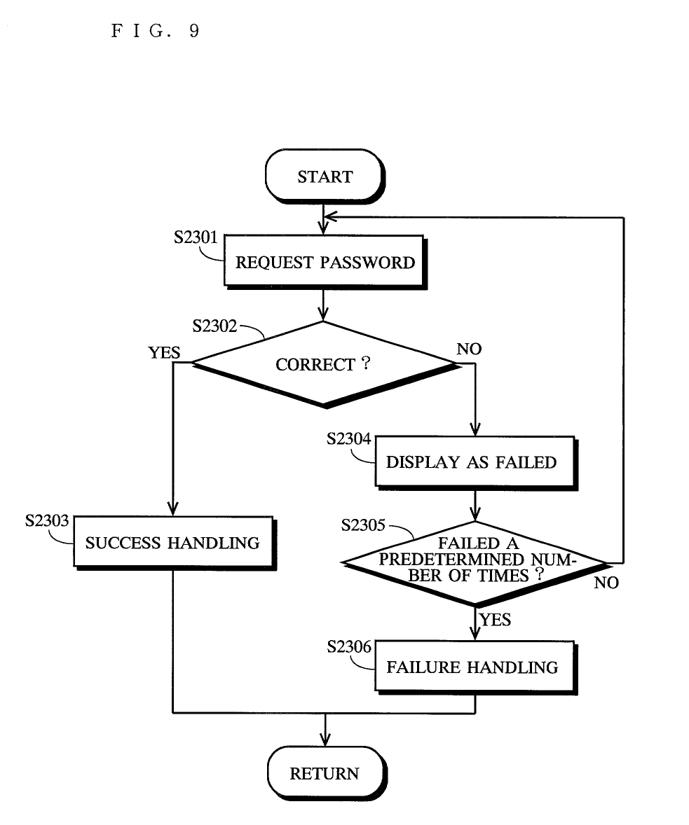

FIG. 7 is a flowchart showing the detailed processing of subroutine step S2 of FIG. 5. First, the authentication part 144 determines whether a time having elapsed after the previous use is within a predetermined time period (step S21). The elapsed time after the previous use is calculated from the previous use time/date data 1322 stored in the vehicle history information storage 132 and data representing the current time/date. If the elapsed time is within the predetermined time period, the authentication part 144 carries out authentication by asking questions about the history information on the registered point (step S22). The details on subroutine step S22 are illustrated in FIG. 8. Here, the predetermined time period is set to be an appropriate time period (three days, for example), for which the user can remember where he/she drove on the previous use. Also, preferably, the predetermined time period can be set in advance by the user. If the elapsed time is not within the predetermined time period, however, the authentication part 144 carries out authentication by asking a question about the personal information (step S23). The details on subroutine step S23 are illustrated in FIG. 9.

FIG. 8 is a flowchart showing the detailed processing of subroutine step S22 of FIG. 7. The authentication unit 144 selects arbitrary one of the registered points (step S2201). The selection in step S2201 is preferably made at random by using random numbers, for example. After selecting the point, the authentication part 144 asks a question through the output unit 12 whether the user passed the selected registered point on the previous use (step S2202). The input unit 11 is supplied with an answer to the question from the user, and outputs the answer to the authentication unit 144. Here, the answer type is Yes or No. Next, the authentication unit 144 determines whether the answer to the question is correct or not (step S2203). The determination in step S2203 is made by comparing the passage date data and the passage time data of the selected registered point in the point information data table 1321, the previous use time/date data 1322, and the data outputted from the input part

The determination processing in step S2203 is described below in detail. When the passage time/date of the selected registered point is after the previous use time/date and the user's answer is Yes (saying he/she passed the point on the previous use), the authentication unit 144 determines that the answer is correct. Similarly, when the passage time/date of the selected registered point is before the previous use time/date and the user's answer is No (saying he/she did not pass the point), the authentication unit 144 determines that the answer is correct. On the other hand, when the passage time/date of the selected registered point is after the previous use time/date and the user's answer is No (saying he/she did not pass the point on the previous use), the authentication unit 144 determines that the answer is incorrect. Similarly, when the passage time/date of the selected registered point is before the previous use time/date and the user's answer is Yes (saying he/she passed the point), the authentication unit 144 determines that the answer is incorrect.

If the answer to the question is correct, the authentication unit 144 determines whether the user passed the selected registered point on the previous use (step S2204). The determination in step S2204 is made by comparing the passage date data and the passage time data of the selected registered point in the point information data table 1321 with the previous use time/date data 1322. If the passage time/date of the selected registered point is after the previous use time/date, the authentication part 144 asks a question through the output unit 12 about what time the user passed the selected registered point on the previous use (step S2205). On the other hand, if the passage time/date of the selected registered point is before the previous use time/date, the authentication part 144 ends questioning about the selected registered point. To the question about what time the user passed the selected registered point on the previous use, the user inputs through the input unit 11 the time when the user thinks he/she passed the selected registered point. The authentication part 144 determines whether the user's answer to the question is correct (step S2206). The determination in step S2206 is made by comparing the data representing the time the user inputted with the passage time data of the selected registered point in the point information data table 1321.

The determination process in step S2206 is described in further detail below. First, the authentication part 144 calculates the difference between the passage time data of the selected registered point and the data representing the time the user inputted. Then, if the difference is within a predetermined time, the authentication part 144 determines that the answer to the question is correct. On the other hand, if the difference is not within the predetermined time, the authentication part 144 determines that the answer is incorrect. Here, in consideration of the fact that the user generally does not exactly remember the time when he/she passed the registered point, the predetermined time is set to a time that provides a margin or error. For example, in a case where the predetermined time is set to ±30 minutes, if the user inputs a time by a margin of ±30 minutes, the authentication unit 144 determines that the answer to the question is correct.

When it is determined in step S2206 that the question about the selected registered point is correct, the authentication part 144 determines whether questioning in a series of processing from steps S2201 to S2206 has been carried out a predetermined number of times (step S2207). If questioning has been carried out the predetermined number of times, the authentication part 144 carries out success handling (step S2208), and ends the procedure.

Here, in the first embodiment, the success handling is carried out as follows. That is, the authentication unit 144 transmits a power-feeding enable signal to the power controller 24, and updates the previous use time/date data 1322. With the power-feeding enable signal supplied to the power controller 24, power is fed from the power supply 22 to the engine 23 for start. Also, the previous use time/date data 1322 stored in the vehicle history information storage 132 is updated by rewriting it to the data representing the current time/date. Thus, the previous use time/date is correctly stored for the next use.

On the other hand, if it is determined in step S2207 that questioning has not been carried out the predetermined number of times, the authentication part 144 repeats the series of processing from steps S2201 through S2206. Here, the predetermined number of times is set for asking questions about the plurality of points in order to ensure authentication, and can preferably be changed by the user.

Described next is the case where the answer to the question about whether the user passed the registered point is incorrect. In this case, the authentication part 144 determines whether the user answered Yes (step S2209). If the answer is Yes, the authentication part 144 asks a question through the output part 12 about what time the user passed the selected registered point (step S2210). The question given in step S2210 is meaningless in view of authentication. However, by giving the same question given when the user's answer to the question about whether the user passed the registered point is correct, the user who gave the incorrect answer to the question in step S2202 cannot tell which answer is incorrect. Therefore, step S2210 can make unauthorized use difficult to achieve.

On the other hand, when it is determined in step S2209 that the answer to the question about whether the user passed the registered point is No, the authentication part 144 does not ask what time he/she passed the selected registered point on the previous use. The authentication part 144 then makes the display part 121 display a screen indicating that authentication has been failed(step S2211). The authentication part 144 also determines whether authentication has been failed a predetermined number of times (step S2212). If authentication has been failed the predetermined number of times, the authentication part 144 carries out failure handling (step S2213), and ends the procedure. Note that the failure handling in the first embodiment includes a process that the authentication part 144 gives an alarm. Specifically, the authentication part 144 makes the output part 12 display an alarm screen and output an alarm sound.

FIG. 9 is a flowchart showing the processing of subroutine step S23 of FIG. 7. First, the authentication part 144 requests the user through the output unit 12 for the password (step S2301). In response, the user enters a password to the input unit 11. The input unit 11 then outputs the entered password to the authentication part 144. The authentication part 144 determines whether the entered password is correct (step S2302). The determination in step S2302 is made by comparing the data representing the password entered by the user with password data 1331 stored in the personal information storage 133. If the entered password is correct, the authentication part 144 carries out success handling (step S2303), and ends the procedure. Note that the success handling in the first embodiment includes a process where the authentication part 144 transmits a power-feeding enable signal to the power controller 24, and updates the previous use time/date data 1322.

On the other hand, it is determined in step S2302 that the entered password is incorrect, the authentication part 144 makes the display part 121 display a screen indicating that authentication has been failed (step S2304). The authentication part 144 also determines whether authentication has been failed a predetermined number of times (step S2305). If authentication has not been failed the predetermined number of times, the authentication part 144 again carries out the processing from step S2301. On the other hand, if authentication has been failed the predetermined number of times, the authentication part 144 carries out failure handling (step S2306), and ends the procedure. Note that the failure handling includes a process where the authentication part 144 makes the output part 12 give an alarm.

The authentication device according to the present embodiment carries out authentication by using, as the vehicle history information, history data representing when and of which predetermined point the user passed. However, the vehicle history information is not restricted to the above, and may be the one representing which point the vehicle passed or which route the vehicle took on the previous travel, for example. Also, authentication may be carried by using, as the vehicle history information, information about the starting point and/or destination on the previous travel. Furthermore, the vehicle history information may be the one representing a value indicated by the gasoline indicator, the one about the speed of the vehicle on the previous travel, or the one representing reception history under VICS.

Further, the authentication device according to the present embodiment carries out authentication by asking a question about whether the user passed, on the previous use, the point selected at random by the authentication part 144 from the registered points. If the user answers Yes, the authentication part 144 further asks a question about approximately what time the user passed that point. Alternatively, one arbitrary point may be selected by the user himself/herself from the registered points, and the authentication part 144 may ask a question about what time the user passed the selected point on the previous use. In this case, the user can select the point he/she remembers the time when he/she passed, and therefore can easily answer the question. This further reduces a burden of remembering on the user.

Still further, the authentication device according to the present embodiment uses the coordinate data of latitudes and longitudes as the positional data representing the positions of predetermined points. Alternatively, links and/or nodes used for cartographic data in car navigation systems may be used as the positional data. In one example method, a link corresponding to a road at a shortest distance from the registered point is stored as the positional data for that point. According to this method, to determine whether the current position of the vehicle matches with the position of the registered point, only required is determining whether the current link matches with the link for the registered point. This advantageously facilitates the determination process, and increases the processing speed.

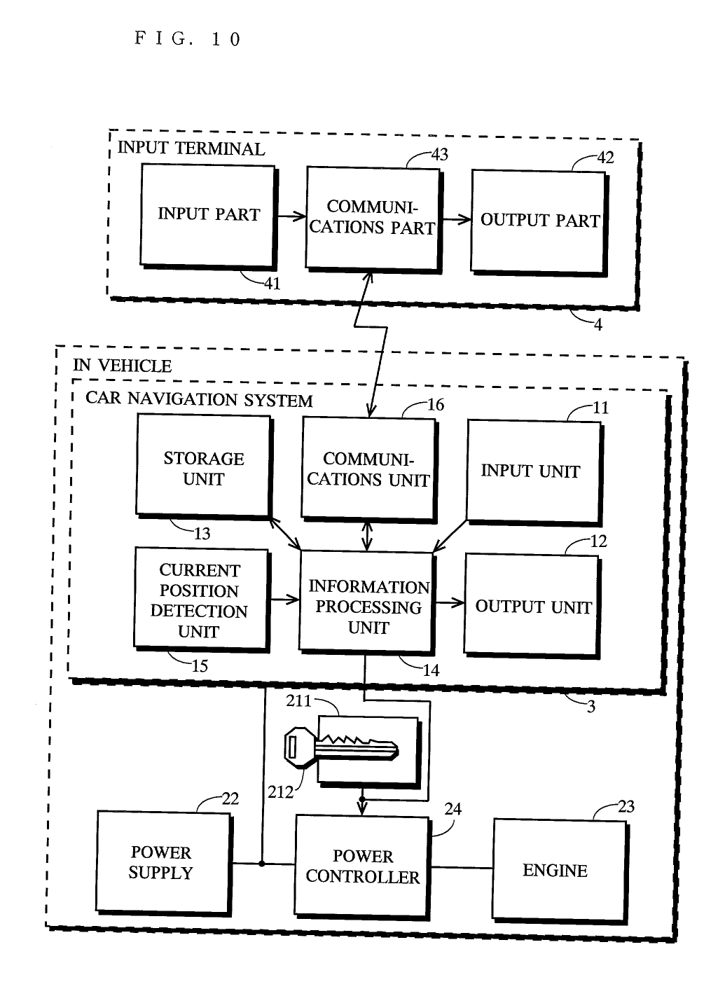

Described next is a second embodiment of the present invention. In an authentication system according to the second embodiment, authentication is carried out for prohibiting use of a vehicle when a key is stolen. FIG. 10 is a block diagram showing the structure of the authentication system according to the second embodiment. In FIG. 10, the authentication system includes a car navigation system 3 mounted on the vehicle, the cylinder 211, the cylinder key 212, the power supply 22, the engine 23, the power controller 24, and the input terminal 24 carried by the user. Note that the authentication system illustrated in FIG. 10 can be achieved by using components similar to those used in the first embodiment. Therefore, in FIG. 10, any component similar to that in FIG. 1 is provided with the same reference numeral, and not described herein.

The car navigation system 3 includes the input unit 11, the output unit 12, the storage unit 13, the information processing unit 14, the current position detection unit 15, and a communications unit 16. As such, the car navigation system 3 can be achieved by adding the communications unit 16 to the components of the car navigation system 1 according to the first embodiment. The communications unit 16 transmits information provided by the information processing unit 14 to an input terminal 4.

The input terminal 4 is used for supplying a question to the user at authentication and receiving an answer from the user. The input terminal 4 includes an input unit 41, an output unit 42, and a communications unit 43. On receiving an input from the user, the input unit 41 outputs a use-disable signal. The use-disable signal is a signal transmitted to the car navigation system 3 for prohibiting the use of the vehicle. On receiving the use-disable signal, the car navigation system 3 starts carrying out authentication for prohibiting the use of the vehicle. The input part 41 also outputs an answer given by the user to the question at authentication to the communications part. The output unit 42 displays a screen indicating the question at authentication, or outputs the question through audio. The communications part 43 wirelessly communicates with the communications part 16 of the car navigation system 3.

Described next is the operation of the authentication system according to the second embodiment for prohibiting the use of the vehicle. First, the input part 41 is supplied with an instruction by the user indicating prohibition of the use of the vehicle, and then outputs a use-disable signal. The use-disable signal is forwarded by the communications part 43 to the car navigation system 3. The communications part 16 of the car navigation system 3 receives the use-disable signal coming from the input terminal 4, and then forwards the signal to the information processing part 14. With the use-disable signal supplied by the communications part 16, the authentication part 144 of the information processing unit 14 starts carrying out authentication. That is, authentication in the second embodiment starts when the authentication part 144 receives the use-disable signal from the communications unit 16.

Authentication carried out by the authentication part 144 is similar to that in the first embodiment illustrated in FIGS. 7 to 9. The question given by the authentication part 144 at authentication is, however, transmitted through the communications unit 16 to the input terminal 4, and then outputted by the output unit 42 of the input terminal 4. To the question outputted from the output unit 42, the user answers through the input unit 41 of the input terminal 4. The answer supplied to the input unit 41 is transmitted through the communications unit 43 to the car navigation system 3.

91 The authentication part 144 also transmits a power-feeding disable signal to the power controller 24 when authentication has succeeded in step S2208 of FIG. 8 or step S2303 of FIG. 9. With the power-feeding disable signal, the power controller 24 prohibits power-feeding done by the cylinder key 212 inserted into the cylinder 211. That is, after the power-feeding disable signal is transmitted from the authentication part 144, power-feeding to the engine 23 is not done even if the cylinder key 212 is inserted into the cylinder 211.

The authentication part 144 also gives an alarm when authentication has been failed in step S2213 of FIG. 8 or step S2306 of FIG. 9. Specifically, the authentication part 144 reports to the input terminal 4 through the communications unit 16 that authentication has been failed. On receiving such report through the communications part 43, the output part 42 displays an alarm screen and outputs an alarm sound.

With the above operation, the authentication system according to the second embodiment prohibits the use of the vehicle done by the cylinder key 21. If the prohibition of the use of the vehicle is canceled, authentication similar to the above is carried out. First, the input part 41 is supplied with an instruction by the user for canceling the prohibition of the use of the vehicle, and outputs a prohibition-canceling signal. The prohibition-canceling signal is forwarded to the car navigation system 3, and then supplied to the authentication part 144. Thus, the authentication part 144 of the information processing unit 14 starts authentication. If authentication has succeeded, the authentication part 144 transmits a power-feeding enable signal to the power controller 24. In response to the power-feeding enable signal, the power controller 24 starts power-feeding from the power supply 22 to the engine 23.

Also, in the authentication system according to the second embodiment, the vehicle can be used through authentication utilizing the vehicle history information. First, the input unit 41 is supplied with a vehicle use instruction from the user, and then outputs a use start signal. The use start signal is transmitted to the car navigation system 3, and then forwarded to the authentication unit 144. Thus, the authentication unit 144 of the information processing unit 14 starts authentication. If authentication has succeeded, the authentication part 144 transmits a power-feeding enable signal to the power controller 24. Supplied with the power-feeding enable signal, the power controller 24 starts power-feeding from the power supply 22 to the engine 23. Note that the power controller 24 gives a higher priority on the power-feeding enable signal coming from the authentication part 144 than the power-feeding disable signal coming from the authentication part 144. Thus, even if the vehicle is under prohibition of power-feeding, authentication done by the authentication system can enable the use of the vehicle.

Note that, in the second embodiment, key authentication is carried out for ordinary use. That is, with the cylinder key 212 inserted into the cylinder 211, the power controller 24 starts power-feeding from the power supply 22 to the engine 23. In this case, the authentication unit 144 of the information processing unit 14 does not carry out authentication. Also, key authentication may depend on the shape of the key as described above, and also may use such technique typically used in an immobilizer that the key containing specific electronic information is used.

Also, in the second embodiment, the input terminal 4 is used for giving questions and answers at authentication. This enables authentication to be carried out without requiring the user to open the door of the vehicle with the cylinder key 212 and get on the vehicle for authentication. In another embodiment, however, the input unit 11 and the output unit 12 of the car navigation system 3 may be used. Furthermore, communications between the communications unit 16 of the car navigation system 3 and the communications unit 43 of the input terminal 4 may be achieved by Bluetooth, but is not restrictive.

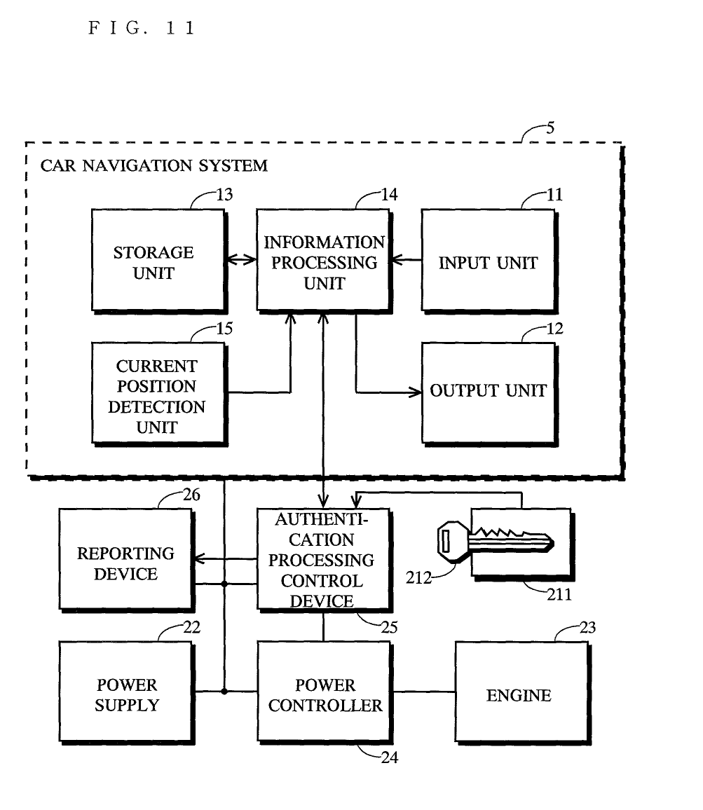

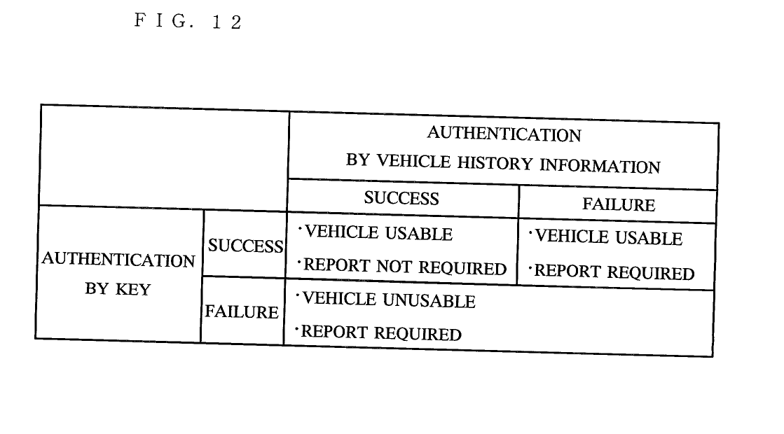

Described next is an authentication system according to a third embodiment of the present invention. A plurality of authentication techniques are used in the authentication system according to the third embodiment, and authentication using the vehicle history information is one of them. FIG. 11 is a block diagram showing the structure of the authentication system according to the third embodiment. In FIG. 11, the authentication system includes the car navigation system 5, the cylinder 211, the cylinder key 212, the power supply 22, the engine 23, the power controller 24, an authentication processing controller 25, and a reporting device 26. The authentication processing controller 25 controls processing carried out on the authentication results of each authentication method. The details on the operation of the authentication processing controller 25 are shown in FIG. 12. The reporting device 26 reports to the user that the vehicle is being used. Note that the authentication system illustrated in FIG. 11 can be realized by using the components similar to those used in the first embodiment. Therefore, in FIG. 11, any component similar to that in FIG. 10 is provided with the same reference numeral, and not described herein.

Described next is the operation of the authentication system according to the third embodiment. FIG. 12 is a table showing what process is carried out or not based on the results of authentication using a plurality of authentication techniques carried out under the authentication system shown in FIG. 11. In the authentication system according to the third embodiment, authentication using the cylinder key 212 and authentication using the vehicle history information are carried out. As shown in FIG. 12, if the authentication using the cylinder key 212 has been failed, the authentication processing controller 25 prohibits the use of the vehicle. In this case, the authentication processing controller 25 also carries out reporting. If the authentication using the cylinder key 212 has succeeded and the authentication using the vehicle history information is failed, the authentication processing controller 25 enables the use of the vehicle, and carries out reporting. For example, reporting is carried out if the cylinder key 212 is stolen and used by an unauthorized person. If the authentication using the cylinder key 212 and the authentication using the vehicle history information both have succeeded, the authentication processing controller 25 enables the use of the vehicle, but does not carry out reporting. The details on the processing of the authentication processing controller 25 are described in detail below.

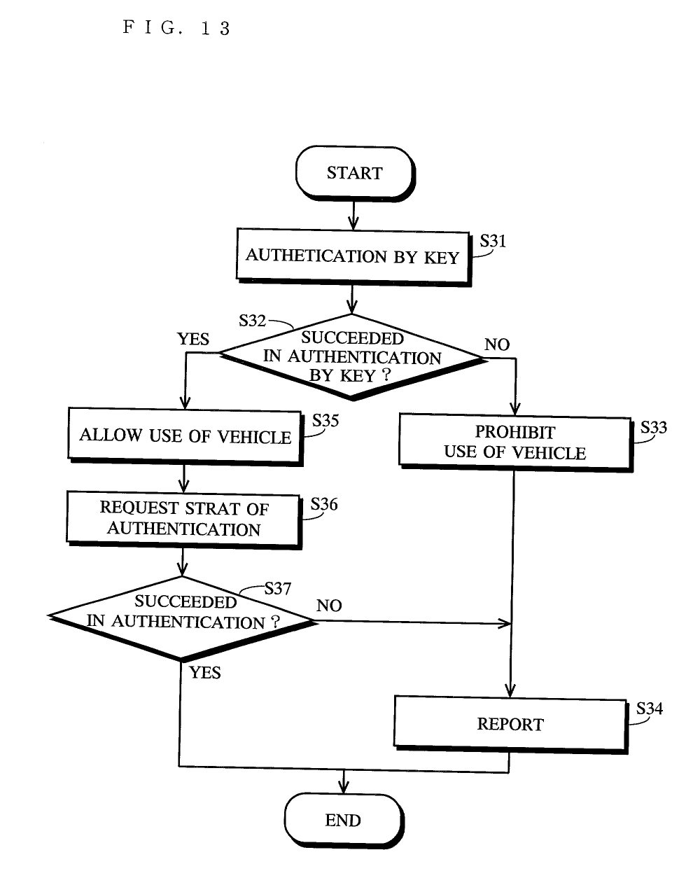

FIG. 13 is a flowchart showing a flow of the processing in the authentication processing controller 25 shown in FIG. 11. The processing in the authentication processing controller 25 is started by the cylinder key 212 inserted into the cylinder 211. First, the authentication processing controller 25 carries out key authentication (step S31). Here, the key authentication is carried out with specific electronic information included in the cylinder key 212, which is typically implemented by an immobilizer. Note that the key authentication is not restricted to the above, and may be carried out based on whether the mechanical cylinder key 212 fits inside the cylinder 211.

The authentication processing controller 25 then determines whether the authentication in step S31 has succeeded (step S32). If the authentication in step S31 has been failed, the authentication processing controller 25 does not transmit a power-feeding enable signal to the power controller 24. Therefore, the engine 23 is not fed with power by the power supply 22, and therefore not started. The authentication processing controller 25 also carries out reporting (step S34), and then ends the procedure. The reporting in step S34 is carried out by the authentication processing controller 25 transmitting a reporting signal to the reporting device 26. With the reporting signal, the reporting device 26 reports to the user, specifically, to a communications terminal (not shown) carried by the user, that the vehicle is possibly being used by an unauthorized person. Note that the manner of reporting made by the reporting device 26 may not be restricted to the above, and may be of any kind as long as the reporting is made to the user.

On the other hand, if it is determined in step S32 that the authentication in step S31 has succeeded, the authentication processing controller 25 allows the use of the vehicle (step S35). The process in step S35 is carried out by the authentication processing controller 25 transmitting a power-feeding enable signal to the power controller 24. In response to the power-feeding enable signal, the power controller 24 starts feeding power from the power supply 22 to the engine 23.

After allowing the use of the vehicle, the authentication processing controller 25 requests the car navigation system 5 to start authentication using the vehicle history information (step S36). Specifically, the authentication processing controller 25 transmits an authentication start signal to the information processing unit 14 of the car navigation system 5. With the authentication start signal, the authentication part 144 of the information processing unit 14 starts authentication. Here, the authentication carried out by the authentication unit 144 is similar to that illustrated in FIGS. 7 to 9. Also, the success handling in step S2208 of FIG. 8 or step S2303 of FIG. 9 includes a process that the authentication part 144 reports to the authentication processing controller 25 that the authentication has succeeded. On the other hand, the failure handling in step S2213 of FIG. 8 or step S2306 of FIG. 9 includes a process that the authentication part 144 reports to the authentication processing controller 25 that the authentication has been failed.

After step S36, the authentication processing controller 25 determines whether the authentication using the vehicle history information has succeeded (step S37). The determination process in step S37 is carried out based on whether a report that the authentication has succeeded has come from the authentication part 144. When it is determined in step S37 that the authentication using the vehicle history information has been failed, the authentication processing controller 25 carries out the process in step S34, and then ends the procedure. On the other hand, when it is determined that the authentication using the vehicle history information has succeeded, the authentication processing controller 25 ends the procedure.

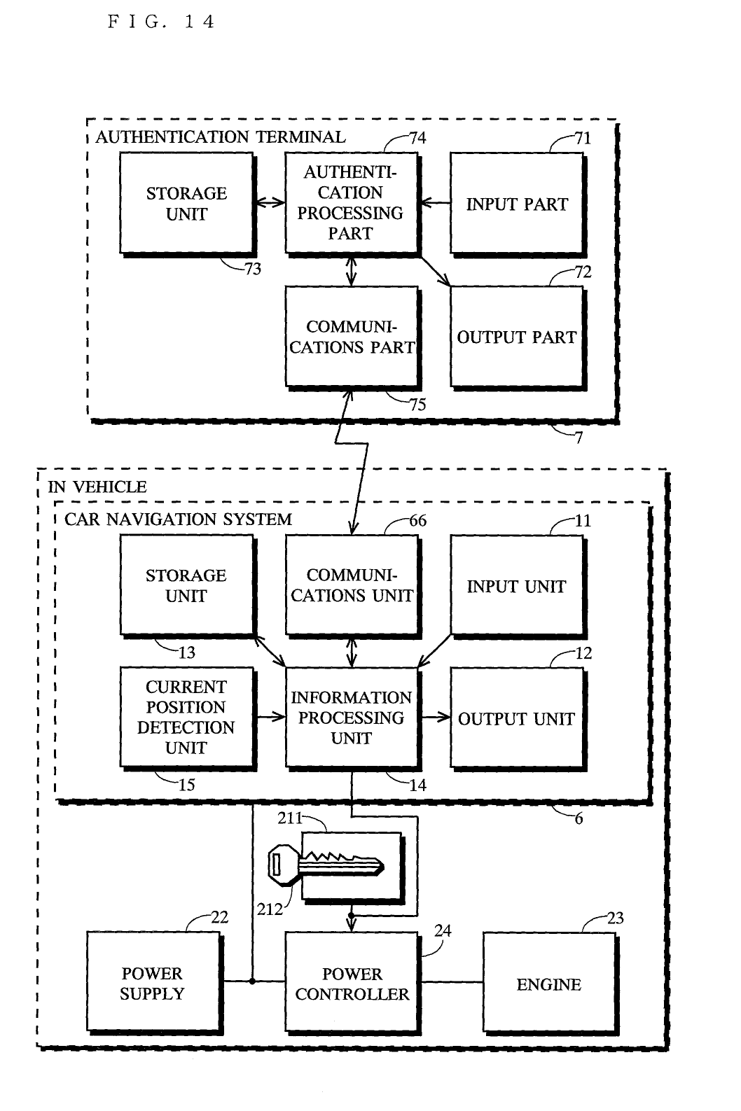

Described next is a fourth embodiment according to the present invention. An authentication system according to the fourth embodiment carries out authentication using the vehicle history information through a terminal carried by the user. FIG. 14 is a block diagram showing the structure of the authentication system according to the fourth embodiment. In FIG. 14, the authentication system includes a car navigation system 6 mounted on a vehicle, the cylinder 211, the cylinder key 212, the power supply 22, the engine 23, the power controller 24, and an authentication terminal 7. Note that the authentication system illustrated in FIG. 14 can be achieved by using the components used in the first embodiment. Therefore, in FIG. 14, any component similar to that of FIG. 1 is provided with the same reference numeral, and not described herein.

The car navigation system 6 includes the input unit 11, the output unit 12, the storage unit 13, the information processing unit 14, the present position detection unit 15, and a communications unit 66. As such, the car navigation system 6 has the structure with the communications unit 66 added to the components of the car navigation system 1 according to the first embodiment. The communications unit 66 transmits/receives data to/from a communications unit 75 of the authentication terminal 7.

The authentication terminal 7 includes an input part 71, an output part 72, a storage unit 73, an authentication processing part 74, and a communications part 75. The input part 71 is used for receiving a user's answer to the question at the time of authentication. The output part 72 outputs an image and audio related to the question at the time of authentication. The storage unit 73 stores the vehicle history information and the personal information required for authentication. The authentication processing part 74 carries out authentication using the vehicle history information. The communications part 75 wirelessly communicates with the communications part 66 of the car navigation system 6.

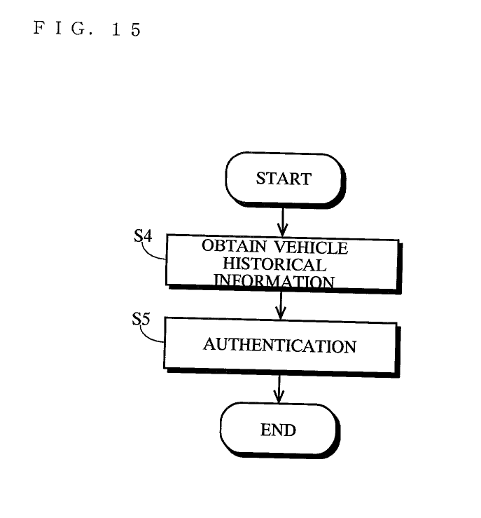

FIG. 15 is a flowchart showing a flow of the processing required for authentication in the authentication terminal 7 illustrated in FIG. 14. First, the authentication terminal 7 obtains the vehicle history information for use in authentication from the car navigation system 6 (step S4). The processing in step S4 is carried out by transmitting the vehicle history information stored in the storage unit 13 of the car navigation system 6 to the authentication terminal 7. More specifically, when the engine of the vehicle is turned OFF, the information processing part 14 transmits the vehicle history information stored in the storage unit 13 through the communications part 66 to the authentication terminal 7. Thus, the vehicle history information gets stored in the storage unit 73 of the authentication terminal 7. Note that when to perform the processing in step S4 is not restricted to the above, and may be immediately before the authentication by the authentication terminal 7, for example.

61 After retrieving the vehicle history information, the authentication terminal 7 carries out authentication (step S5). The authentication process in step S5 is started when the authentication processing part 74 is supplied by the user through the input part 71 with an instruction for starting authentication. Here, the authentication process in step S5 is similar to that in authentication part 144 shown in FIGS. 7 through 9 according to the first embodiment. For the success handling in step S2208 of FIG. 8 or step S2303 of FIG. 9, the authentication processing part 74 reports to the car navigation system 6 that the authentication has succeeded. Note that the reporting from the authentication terminal 7 to the navigation system 6 is made typically with authentication, electronic signature, or encryption. This prevents unauthorized external operation onto the reporting.

On receiving the report that the authentication has succeeded, the information processing part 14 of the car navigation system 6 transmits a power-feeding disable signal to the power controller 24. With the power-feeding disable signal, the power controller 24 prohibits power-feeding done by the cylinder key 212 inserted into the cylinder 211. That is, after the power-feeding disable signal is transmitted from the authentication part 144, power-feeding to the engine 23 is not done even if the cylinder key 212 is inserted into the cylinder 211. Note that the power controller 24 gives a higher priority on the power-feeding enable signal from the authentication part 144 than the power-feeding disable signal from the authentication part 144. Thus, even if the vehicle is under prohibition of power-feeding, authentication done by the authentication system can enable the use of the vehicle.

For the failure handling in step S2213 of FIG. 8 or step S2306 of FIG. 9, the authentication part 144 gives an alarm. Specifically, the authentication part 144 reports to the authentication terminal 7 through the communications unit 66 that the authentication has been failed. On receiving the report through the communications unit 75, the authentication processing part 74 makes the output unit 42 display an alarm screen and output an alarm sound.

As stated above, in the fourth embodiment, the authentication terminal 7 is used for prohibiting the use of the vehicle. Here, in another embodiment, the authentication terminal 7 may be used for enabling the use of the vehicle. Therefore, the authentication terminal 7 used in the authentication system according to the fourth embodiment can be used also in the first embodiment. In this case, the user can carry out authentication in advance outside the vehicle through the authentication terminal 7. Therefore, the user is not bothered with burdensome authentication when getting on the vehicle.

Also, in the fourth embodiment, authentication in the authentication terminal 7 is carried out for enabling or prohibiting the use of the vehicle. Here, in another embodiment, use purposes of the authentication terminal 7 are not restricted to the one related to the use of the vehicle. For example, if the authentication terminal 7 has a function of payment, authentication carried out thereby is for authenticating the user. In this case, to authenticate the user, the authentication using the vehicle history information can be utilized.

Furthermore, the power controller 24 provided in the first, second, third, and fourth embodiments is not necessarily a unit for restricting power-supply to the engine, but may be a unit capable of controlling the use of the vehicle.

While the invention has been described in detail, the foregoing description is in all aspects illustrative and not restrictive. It is understood that numerous other modifications and variations can be devised without departing from the scope of the invention.

What is claimed is:

1. An authentication device for authenticating a user of a vehicle, comprising:
a vehicle history information detecting part for detecting vehicle history information varying with use of said vehicle;
a vehicle history information storage part for storing the vehicle history information detected by said vehicle history information detection part;
an output part for outputting a question about said vehicle history information;
an answer input part being supplied with an answer from the user to the question about said vehicle history information; and
a user authentication part for authenticating the user based on the vehicle history information stored in said vehicle history information storage part and the answer from said user.

2. The authentication device according to claim 1, wherein
said vehicle history information includes point history information indicating history of one or more predetermined points.

3. The authentication device according to claim 2, wherein
said point history information includes, for one or more registered points registered in advance by said user, information about time/date when said vehicle previously passed said registered points and time/date when said vehicle was used on a previous use.

4. The authentication device according to claim 3, wherein
said user authentication part selects an arbitrary point from said registered points, and
said output part outputs a question about whether said vehicle passed, on the previous use, the point selected by said user authentication part and, if said vehicle passed the point, a question about what time said vehicle passed the point on the previous use.

5. The authentication device according to claim 3, wherein
said answer input part is supplied with a point selected by said user from said registered points, and
said output part outputs a question about when said vehicle previously passed the point supplied to said answer input part.

6. The authentication device according to claim 1, further comprising a personal information storage part for storing information unique to said user and/or personal information including a password previously set by said user, wherein
said output part outputs the question about said vehicle history information when an elapsed time after the previous use of said vehicle is within a predetermined time period, and a question about personal information when said elapsed time is over said predetermined time period,
said answer input part is supplied with the answer from the user to the question about said vehicle history information when the elapsed time is within the predetermined time period, and an answer to the question about said personal information when said elapsed time is over the predetermined time period, and
said user authentication part authenticates the user based on said vehicle history information and the answer from said user when said elapsed time is within the predetermined time period, and based on said personal information and the answer from said user when said elapsed time is over the predetermined time period.

7. The authentication device according to claim 1, further comprising:
a power-feeding part for carrying out power-feeding to an engine of the vehicle, wherein
said user authentication part makes said power-feeding part carry out the power-feeding if having authenticated the user.

8. The authentication device according to claim 1, further comprising:
a power-feeding part for carrying out power-feeding to an engine of the vehicle;
a key authentication part for carrying out authentication using a key, and if having authenticated the key, making said power-feeding part carry out power-feeding; and
a restrictive instruction input part being supplied with an instruction for restricting the use of said vehicle, wherein
said user authentication part carries out authentication in response to the instruction for restricting the use of said vehicle and, if having authenticated the user, prohibits said power-feeding part from carrying out the power-feeding done by said key authentication part.

9. The authentication device according to claim 8, further comprising a use instruction input part being supplied with an instruction for using said vehicle, wherein
said user authentication part carries out authentication in response to the instruction for using said vehicle and, if having authenticated the user, makes said power-feeding part carry out the power-feeding.

10. The authentication device according to claim 1, further comprising:
a power-feeding part for carrying out power-feeding to an engine of the vehicle;
a key authentication unit for carrying out authentication using a key and, if having authenticated the key, making said power-feeding part carry out the power-feeding; and
a reporting part for reporting to the user that the vehicle is under unauthorized use, when said user authentication part has not authenticate the user within a predetermined time period after said power-feeding part carried out the power-feeding.

11. The authentication device according to claim 1, wherein
the authentication device is constructed as part of a car navigation system.

12. An authentication device capable of communicating with an input terminal that outputs a question about vehicle history information varying with use of a vehicle and is supplied with an answer to the question, said authentication device comprising:
a vehicle history information detection part for detecting said vehicle history information;
a vehicle history information storage part for storing the vehicle history information detected by said vehicle history information detection part;
a communications part for transmitting the question about said vehicle history information and receiving the answer to the question from a user through the input terminal; and
a user authentication part for authenticating the user based on the vehicle history information stored in said vehicle history storage part and the answer from said user.

13. An authentication system including a vehicle mounted authentication device for authenticating a user of a vehicle, and an input terminal capable of communicating with the authentication device, wherein
said authentication device comprises:
a vehicle history information detection part for detecting vehicle history information varying with use of the vehicle;
a vehicle history information storage part for storing the vehicle history information detected by said vehicle history information detection part;
a communications part for transmitting a question about said vehicle history information to said input terminal and receiving an answer to the question from the user through the input terminal; and
a user authentication part for authenticating the user based on the vehicle history information stored in said vehicle history information storage part and the answer from the user, and
said input terminal comprises:
a terminal-side output part for outputting the question about said vehicle history information transmitted by said authentication device;
a terminal-side answer input part being supplied with the answer from the user to the question about said vehicle history information; and
a terminal-side communications part for transmitting the answer from said user to said authentication device.

14. The authentication system according to claim 13, wherein
said authentication device further comprises:
a power-feeding part for carrying out power-feeding to an engine of the vehicle; and
a key authentication part for carrying out authentication using a key and, if having authenticated the key, making said power-feeding part carry out the power-feeding, and
said user authentication part carries out the authentication in response to an instruction for restricting the use of said vehicle and, if having authenticated the user, prohibits said power-feeding part from carrying out the power-feeding done by said key authentication part.

15. The authentication system according to claim 14, wherein
said input terminal further comprises a terminal-side use instruction input part being supplied with an instruction for using said vehicle, and
said user authentication part carries out the authentication in response to the instruction for using said vehicle and, if having authenticated the user, makes said power-feeding part carry out the power-feeding.

16. An authentication system including a vehicle-side device mounted on a vehicle and an authentication terminal capable of communicating with the vehicle-side device, wherein
said vehicle-side device comprises:
a vehicle history information detection part for detecting vehicle history information varying with use of said vehicle; and
a communications part for transmitting the vehicle history information detected by said vehicle history information detection part to said authentication terminal, and
said authentication terminal comprises:
a terminal-side vehicle history information storage part for storing the vehicle history information transmitted from said communications part;
a terminal-side output part for outputting a question about said vehicle history information;
a terminal-side answer input part being supplied with an answer from a user to the question about said vehicle history information; and
a terminal-side user authentication part for authenticating the user based on the vehicle history information stored in said terminal-side vehicle history information storage part and the answer from said user.

17. The authentication system according to claim 16, wherein
said authentication terminal further comprises a terminal-side communications part for transmitting an authentication result given by said terminal-side user authentication part to said vehicle-side device, and
said vehicle-side device further comprises anti-theft processing part for carrying out processing for preventing theft of said vehicle based on the authentication result received from said terminal-side communications part.

18. The authentication system according to claim 17, wherein
said anti-theft processing part comprises a power-feeding part for carrying out power-feeding to an engine of the vehicle,
said vehicle-side device further comprises a key authentication part for carrying out authentication using a key and, if having authenticated the key, making said power-feeding part carry out the power-feeding, and
said terminal-side user authentication part carries out authentication in response to an instruction for restricting use of said vehicle and, if having authenticated the user, makes said terminal-side communications part transmit a power-feeding disable signal to said power-feeding part, thereby prohibiting said power-feeding part from carrying out the power-feeding done by said key authentication part.

19. The authentication system according to claim 18, wherein
said authentication terminal further comprises a terminal-side use instruction input part being supplied with an instruction for using said vehicle, and
said terminal-side user authentication part carries out the authentication in response to the instruction for using said vehicle and, if having authenticated the user, makes said terminal-side communications part transmit a power-feeding signal to said power-feeding part, thereby making said power-feeding part carry out the power-feeding.

20. The authentication system according to claim 16, wherein
said vehicle-side device further comprises a vehicle history information storage part for storing the vehicle history information detected by said vehicle history information detection part, and
when the use of the vehicle ends, said communication part transmits the vehicle history information stored in said vehicle history information storage part to said authentication terminal.

21. An input terminal capable of communicating with a vehicle-mounted authentication device for authenticating a user of a vehicle, said input terminal comprising:
a terminal-side output part for outputting a question about vehicle history information varying with use of the vehicle transmitted from said authentication device;
a terminal-side answer input part being supplied with an answer from the user to the question about said vehicle history information; and
a terminal-side communications part for transmitting the answer from said user to said authentication device.

22. An authentication terminal capable of communicating with a vehicle-side device for detecting vehicle history information varying with use of a vehicle, said authentication terminal comprising:
a terminal-side communications part for receiving, from the vehicle-side device, the vehicle history information detected by said vehicle-side device;
a terminal-side vehicle history information storage part for storing the vehicle history information received by said communications part;
a terminal-side output part for outputting a question about said vehicle history information;
a terminal-side answer input part being supplied with an answer from the user to the question about said vehicle history information; and
a terminal-side user authentication part for authenticating the user based on the vehicle history information stored in said vehicle history information storage part and the answer from said user.

23. A method for authenticating a user of a vehicle, comprising the steps of:
detecting vehicle history information varying with use of said vehicle;
storing said vehicle history information;
asking a question about said vehicle history information;
receiving an answer from the user to said question; and
authenticating the user based on said vehicle history information and the answer from said user.
